(19) United States
(12) Patent Application Publication
(10) Pub. No.: US 2005/0278504 A1
(43) Pub. Date: Dec. 15, 2005

(54) System capable of dynamically arranging coprocessor number

(75) Inventor: Ming-Chuan Huang, Fongyuan City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 11/041,302

(22) Filed: Jan. 25, 2005

(30) Foreign Application Priority Data
Jun. 15, 2004 (TW) 093117161

(51) Int. Cl. G06F 15/00

(52) U.S. Cl. 712/34

(57) ABSTRACT

A system capable of dynamically arranging coprocessor number, which uses a coprocessor instruction to be an instruction between a master processor and one or more coprocessors. The system includes plural coprocessors and a master processor. The plural coprocessors help the master processor to perform additional operations. The master processor executes plural instructions for data operations and applies the coprocessor instruction for data access and communication between the master processor and the coprocessors. The coprocessor instructions have at least one rearranged coprocessor instruction field and one main instruction opcode field each. The rearranged coprocessor instruction field has fields of coprocessor number, coprocessor opcode number and coprocessor register, or fields of coprocessor number and coprocessor register.

### BACKGROUND OF THE INVENTION

1. Field of the Invention

The invention relates to an embedded system with coprocessors and, more particularly, to a system capable of dynamically arranging coprocessor number.

2. Description of Related Art

Typically, portable electronics have high mobility, so that the users increasingly welcome them. A user typically has lower requirement for the operational capabilities of portable electronics such as a personal multimedia player (PMP), which, for example, only needs the memorandum management, translation, and the fundamental operations of arithmetic. The portable electronics are configured using embedded systems. The embedded systems typically use processors of ARMx, MIPS and StrongARM to thus save power. The processors used by the embedded systems are different from a general microprocessor at their operational capability, clock speed, and default instructions to process a variety of multimedia. In order to improve it, the embedded systems use coprocessors to cooperate with a master processor, thereby enhancing required functions. For example, a master processor cooperates with a coprocessor having audio decoding or video decoding to provide with the multimedia solution.

FIG. 1 is a schematic diagram of a typical embedded system 100. In FIG. 1, the system 100 includes a master processor 110, a first coprocessor 120, a second coprocessor 130 and a memory 140. As shown in FIG. 1, the master processor 110 provides the embedded system 100 with major operations. The first coprocessor 120 provides with additional operations such as audio playing. The second coprocessor 130 provides with additional operations such as video playing. The memory 140 provides with data storage. The first and the second coprocessors 120 and 130 cannot access the memory 140 directly because of no direct connection.

An interface architecture between the master processor and the coprocessors is shown in FIG. 1. Typically, a coprocessor instruction is executed according to the following steps: the master processor 110 sends an instruction fetch request to the memory 140; the master processor 110 in a decoding stage sends a coprocessor instruction to the coprocessors through the coprocessor interface; the coprocessors in the decoding stage or a next stage decode the coprocessor instruction to accordingly determine a respective coprocessor that the coprocessor instruction belongs; the respective coprocessor sends an acknowledgement signal to the master processor 110 such that the master processor 110 completes the coprocessor instruction through the coprocessor interface; and if no acknowledgement signal is sent to the master processor 110, the master processor 110 enters into an undefined instruction exception.

Typical coprocessor instructions for a master processor have three types. The first type, such as MCR, MRC, MTC/MFC instructions, moves the content of a register of the master processor to/from a coprocessor register. The second type, such as STC, LDC instructions, moves data between memory and coprocessor register. The third type, such as CDP, COP instructions, is the data operational instructions of coprocessor.

The three types define the fundamental operational capabilities of a coprocessor and the method of data exchange between a master processor and the coprocessor. FIG. 2 shows the formats of coprocessor instructions for a master processor. An embedded system with the master processor will limit the hardware and software design of its coprocessors in accordance with the formats of coprocessor instructions. For example, FIG. 2 has a 4-bit CoProc# field, which limits the coprocessor number of an embedded system to 16, and a 4-bit Opcode field also limits the operational instruction number of a coprocessor to 16.

Most coprocessor instructions have two fields of coprocessor number (CoProc#) and coprocessor op-code (Opcode), each field having fixed bit number (four bits). Namely, an embedded system can have 16 coprocessors at most and each coprocessor can have 16 functional instructions (opcode) and 16 registers at most. Since an embedded system gives each coprocessor a unique identification (ID) to identify, when the embedded system requires the coprocessor number over its upper limit (16), the prior system with the master processor cannot handle it.

Further, when a single coprocessor has a number of opcodes larger than its upper limit (16), the prior system with the master processor has to design the single coprocessor as several sub-coprocessors having individual hardware, which increases the complexity of hardware and software design. Therefore, it is desirable to provide an improved system to mitigate and/or obviate the aforementioned problems.

### SUMMARY OF THE INVENTION

The object of the invention is to provide a system for dynamically arranging formats of coprocessor instructions, so as to flexibly arrange coprocessor opcode numbers and coprocessor numbers in design, thereby speeding associated hardware interface and software program development.

To achieve the object, there is provided a system capable of dynamically arranging coprocessor number, which uses a coprocessor instruction for communication and data transfer. The system comprises: plural coprocessors, which execute respective operations; and a master processor, which executes plural instructions for data operations and applies the coprocessor instruction to the coprocessors for communication and data transfer, thereby obtaining required results or intermediate values from the respective operations; wherein the coprocessor instruction has a rearranged coprocessor instruction field and a main instruction opcode field, and the rearranged coprocessor instruction field has fields of coprocessor number field, coprocessor opcode number and coprocessor register or fields of coprocessor number and coprocessor register.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a typical embedded system;

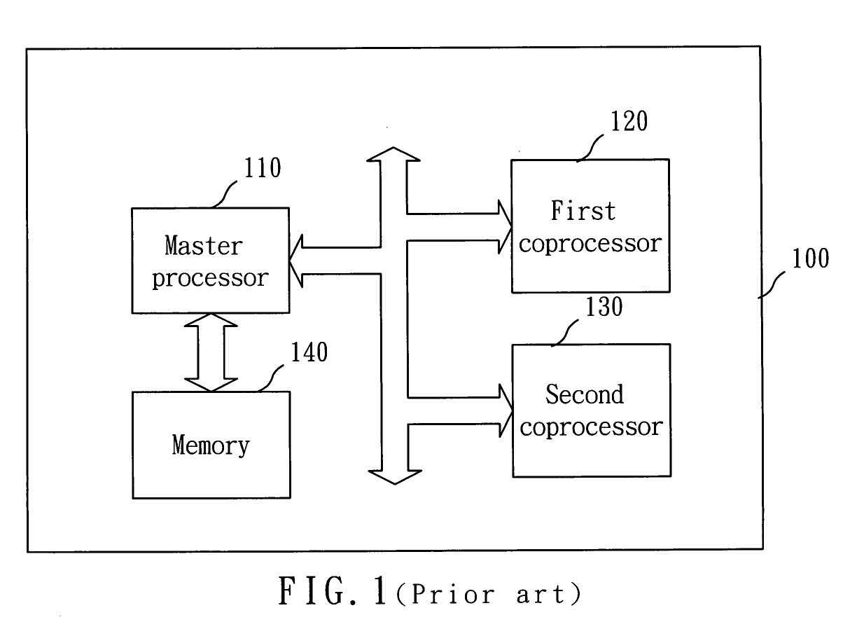

FIG. 2 schematically illustrates typical formats of coprocessor instructions;

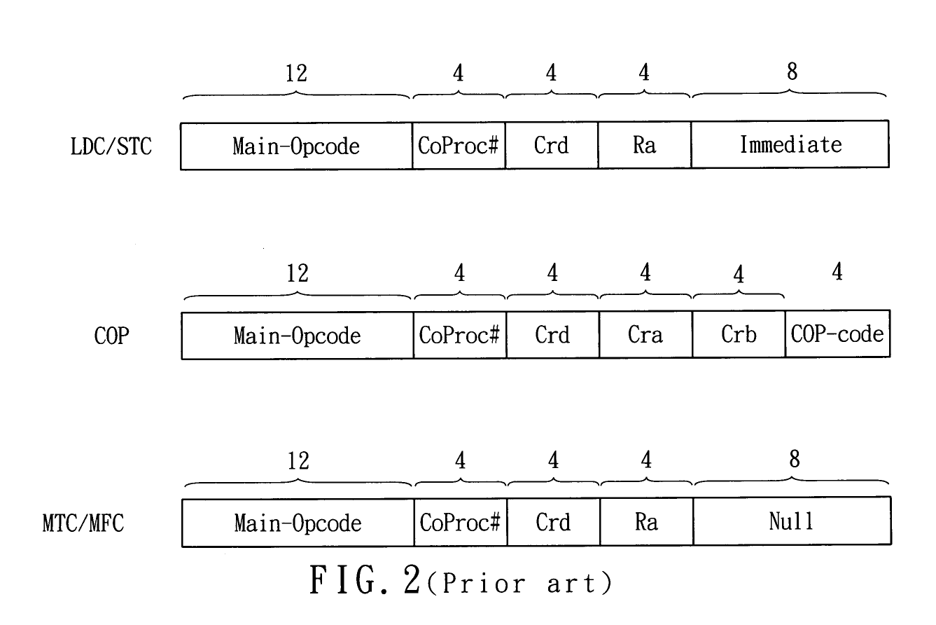

FIG. 3 schematically illustrates formats of coprocessor instructions according to the invention;

FIG. 4 schematically illustrates typical single precision coprocessor instruction coding;

FIG. 5 schematically illustrates typical double precision coprocessor instruction coding;

FIG. 6 is an embodiment according to the invention; and

FIG. 7 is another embodiment according to the invention.

### DETAILED DESCRIPTION OF THE PREFERRED EMBODIMENT

The invented system capable of dynamically arranging coprocessor number applies a coprocessor instruction for access data and communication between a master processor and one or more coprocessors. The system includes plural coprocessors and a master processor. The coprocessors help the processor to perform additional operations. The processor executes plural instructions for data operations and applies the coprocessor instruction for data access and communication between the processor and the coprocessors. The coprocessor instruction includes a rearranged coprocessor instruction field and a main instruction opcode field. The rearranged coprocessor instruction field includes fields of coprocessor number, coprocessor opcode number and coprocessor registers, or fields of coprocessor number and coprocessor registers.

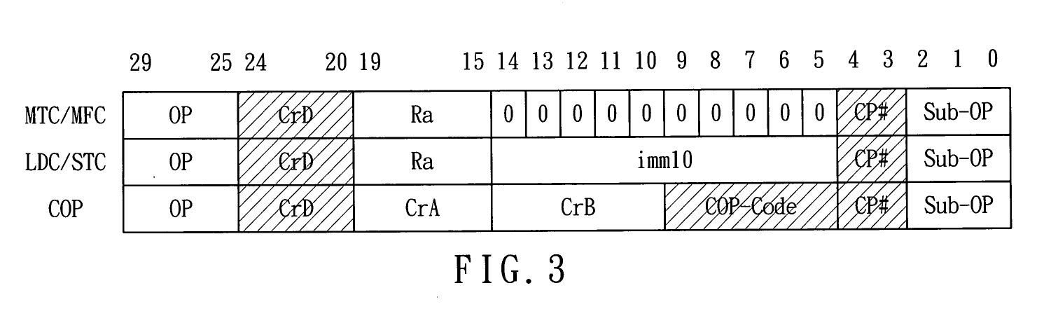

FIG. 3 schematically illustrates formats of coprocessor instructions according to the invention, which shows three types of coprocessor instructions. The first type, such as MTC/MFC instructions, moves a register content of the master processor to a coprocessor register. The second type, such as STC/LDC instructions, moves data between memory and coprocessor register. The third type, such as COP instruction, is the data operational instructions of coprocessor. As shown in FIG. 3, the non-data operational instructions such as LDC/STC/MTC/MFC include a coprocessor number field CP# and a coprocessor register field CrD. The data operational instructions such as COP include fields of coprocessor number CP#, coprocessor opcode number COP-Code and coprocessor registers CrA, CrB, CrD.

As shown in the fields of FIG. 3 in skewed lines, the formats of coprocessor instructions are rearranged, wherein the fields of coprocessor number CP# and coprocessor register CrD in the LDC/STC/MTC/MFC instructions, or the fields of coprocessor number CP#, coprocessor opcode number COP-Code and coprocessor register CrD in the COP instruction are combined into a rearranged coprocessor instruction field.

According to the formats of coprocessor instructions of FIG. 3, an embedded system configured by a master processor applying the formats of coprocessor instructions can have resources of at most four coprocessors, each having at most 32 registers and 32 opcode numbers.

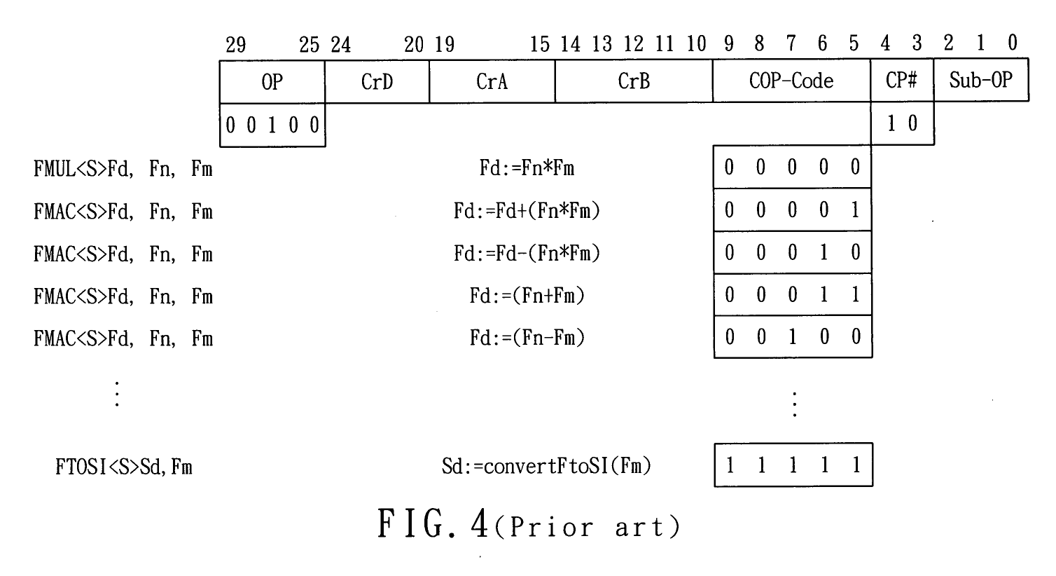

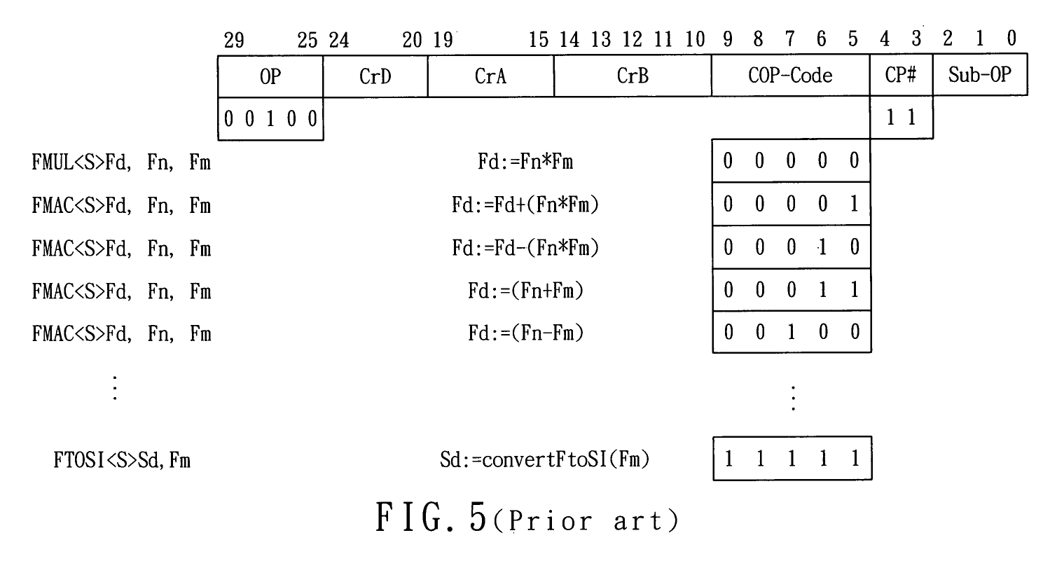

If the embedded system needs a coprocessor with a function of single and double precise floating operations to handle a complete instruction of floating operation, the coprocessor requires an opcode number more than 32 and a register number less than 16. In this case, with the formats of coprocessor instructions in the prior art, the embedded system needs two separate coprocessors: one as a single precise coprocessor and the other as a double precise coprocessor, each coprocessor having 16 registers in the format of coding as shown in FIGS. 4 and 5.

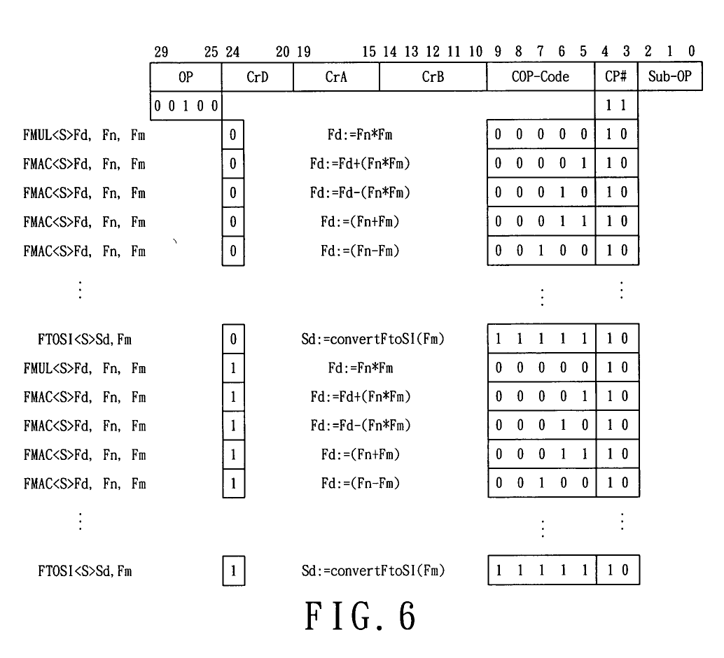

The invention regards three fields of Coprocessor Register, COP-Code and CP# as a rearranged coprocessor instruction field such that the two separate coprocessors in the prior design can be combined into a single coprocessor in hardware design, which has a rearranged format for the coprocessor instructions as shown in FIG. 6, without changing its operational manner.

Accordingly, for the coding of FIGS. 4 and 5, two coprocessors in a system are used, but for the coding of FIG. 6, only one coprocessor in the system is used. In practical hardware design, the coprocessor using the coding of FIG. 6 encodes the MSB of coprocessor register CrD by regarding it as a bit of coprocessor operation coding. In order to achieve this, a slight change is undertaken as designing an instruction decoding circuit for the coprocessor, i.e., adding the MSB of coprocessor register CrD to the instruction decoding circuit, since the number of registers required for the coprocessor is no more than 16. Such a way does not change any coprocessor operation.

When all coprocessors with a function of single and double precise floating operations of FIG. 6 apply a same number to the rearranged coprocessor instruction field, a coprocessor ID jumper is used as the system integrates the coprocessors such that for a same time point, the rearranged coprocessor instruction field has a unique number. Also, as the system dynamically operates, the coprocessor with a function of single and double precise floating operations can use a device enable register, such that, for a same time point, the rearranged coprocessor instruction field has a unique number.

The coprocessor instructions are executed and operated completely by the cooperation between the master processor and the coprocessors through the coprocessor interface. The master processor determines whether the current instruction is a coprocessor instruction, whether any coprocessor responses the coprocessor instruction, and which type (COP, LDC, STC, MTC or MFC) the coprocessor instruction is. When handling an instruction, the master processor decodes Main-OP field and Sub-OP field to accordingly determine the instruction as a coprocessor instruction. The remaining fields, CP#, COP-Code and Coprocessor Register, can be handled by the coprocessors. At this point, the invention can use the rearranged coprocessor instruction field, which contains the fields of CP#, COP-Code and Coprocessor Register, to develop the most design possibility of system level in microprocessor applications.

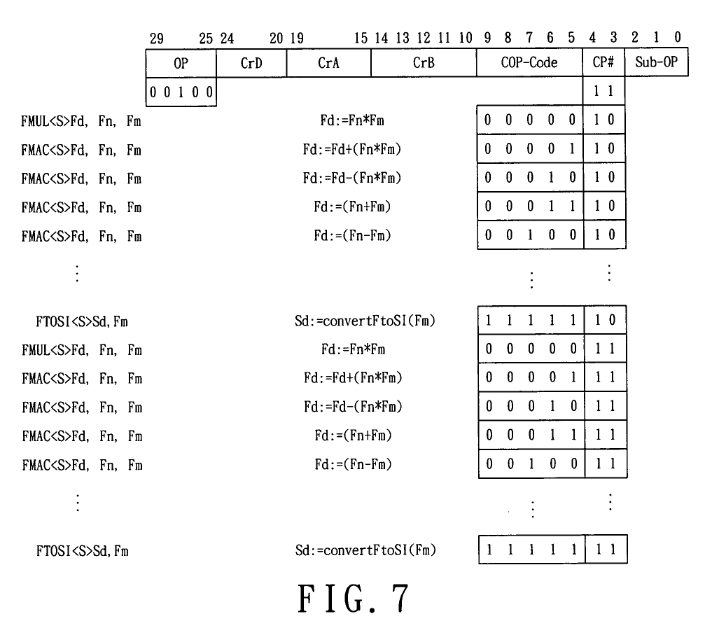

FIG. 7 shows another embodiment according to the invention. When a number of coprocessors required by an embedded system is less than two, the LSB in the coprocessor number field CP# can be regarded as a bit of coprocessor operation coding in use, which can be achieved by adding the LSB bit of the coprocessor number field CP# to the instruction decoding field of the coprocessors in design.

As cited, the invention regards the fields of Coprocessor Register, COP-Code and CP# as a rearranged coprocessor instruction field such that in designing the coprocessors for an embedded system, the COP-Code field can be extended appropriately, and the embedded system can have on-demand coprocessor number to thus speed up associated hardware interface and software program development.

Although the present invention has been explained in relation to its preferred embodiment, it is to be understood that many other possible modifications and variations can be made without departing from the spirit and scope of the invention as hereinafter claimed.

1. A system capable of dynamically arranging coprocessor number, which uses a coprocessor instruction for communication and data transfer, the system comprising:
plural coprocessors, which execute respective operations; and
a master processor, which executes plural instructions for data operations and applies the coprocessor instruction to the coprocessors for communication and data transfer, thereby obtaining required results or intermediate values from the respective operations;
wherein the coprocessor instruction has a rearranged coprocessor instruction field and a main instruction opcode field, and the rearranged coprocessor instruction field has fields of coprocessor number field, coprocessor opcode number and coprocessor register or fields of coprocessor number and coprocessor register.

2. The system as claimed in claim 1, wherein when the coprocessors apply a same number to the rearranged coprocessor instruction field, a coprocessor ID jumper is used as integrating the coprocessors, such that, for a same time point, the rearranged coprocessor instruction field has a unique number.

3. The system as claimed in claim 2, wherein when the master processor sends a coprocessor instruction to the coprocessors, one of the coprocessors produces an acknowledgement in response to the coprocessor instruction.

4. The system as claimed in claim 3, wherein the rearranged coprocessor instruction field is decoded by the corresponding coprocessor.

5. The system as claimed in claim 3, wherein the master processor enters in an undefined instruction exception as no acknowledgement is received.

6. The system as claimed in claim 1, wherein when the coprocessors apply a same number to the rearranged coprocessor instruction field, a device enable register is used as the system dynamically operates, such that, for a same time point, the rearranged coprocessor instruction field has a unique number.

7. The system as claimed in claim 1, wherein the field of coprocessor number has at least bit number as 1.

8. The system as claimed in claim 1, wherein the field of coprocessor opcode number has at least bit number as 1 for one of the coprocessors.

9. The system as claimed in claim 1, wherein the field of coprocessor register has at least bit number as 1 for one of the coprocessors.

10. The system as claimed in claim 1, wherein for a time point, the rearranged coprocessor instruction field is unique.
